(19) United States
(12) Patent Application Publication
(10) Pub. No.: US 2005/0193787 A1
(43) Pub. Date: Sep. 8, 2005

(54) Door lock lever hold

(76) Inventor: Hollis Washington Davis, Chamblee, GA (US)

Correspondence Address: HOLLIS WASHINGTON DAVIS, P.O. BOX 56013, ATLANTA, GA, 30343, US

(21) Appl. No.: 11/035,496

(22) Filed: Jan. 14, 2005

Related U.S. Application Data
(60) Provisional application No. 60/539,260, filed on Jan. 27, 2004.

(51) Int. Cl. E05B 13/00

(52) U.S. Cl. 70/416

(57) ABSTRACT

The nature of my invention is to hold the turn lever knob for some home entrance doors in it's set position even when a key is used from the outside side of the door for the dead bolt door lock system. There are no moving parts and no construction modifications are required when the corresponding size device is used. The device interlocks with the rectangular turn lever knob controlling the locking function at the top of the device while also interlocks with the door knob and the door knob's axle at the lower end to counter resist against the use of a key from the outside to unlock the lock. The device is useful when dead bolt lock key is missing, lost or stolen. Until the lock is replaced entrance with a key must be granted by the person on the inside side of the entrance door.

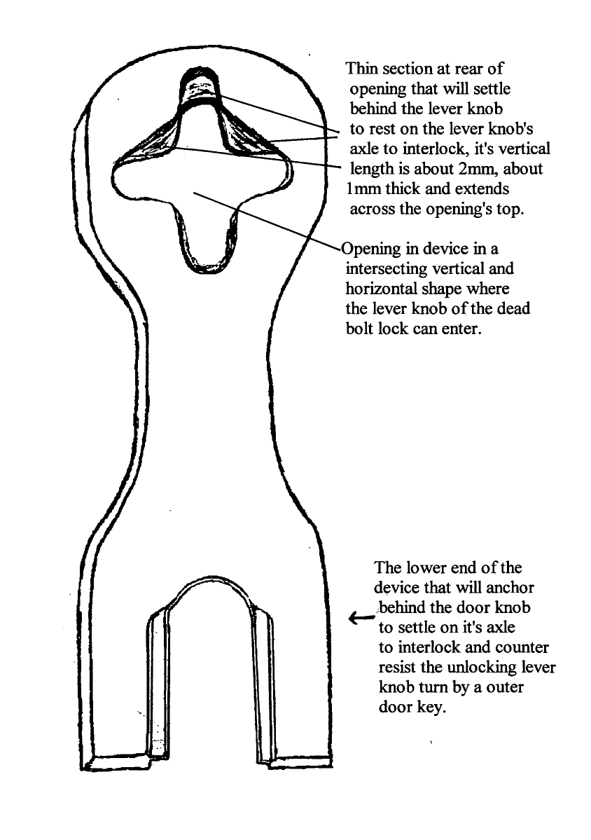

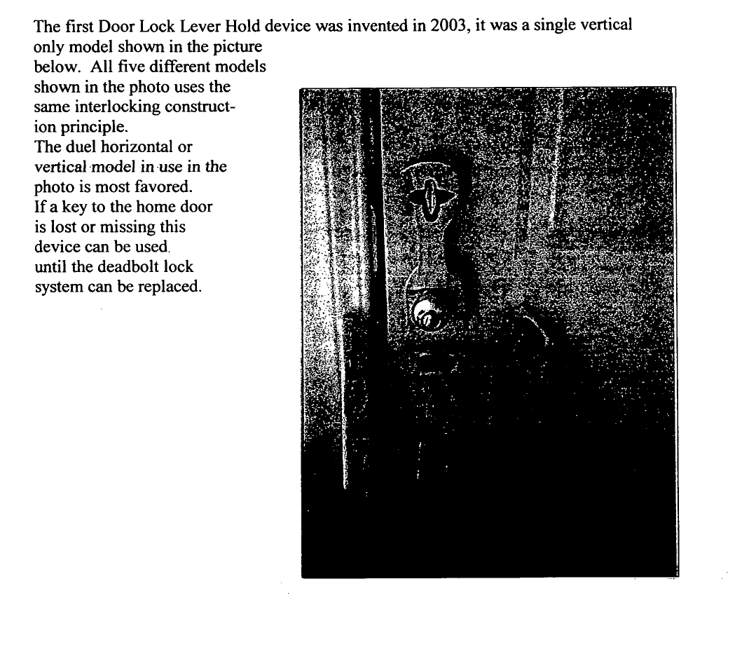

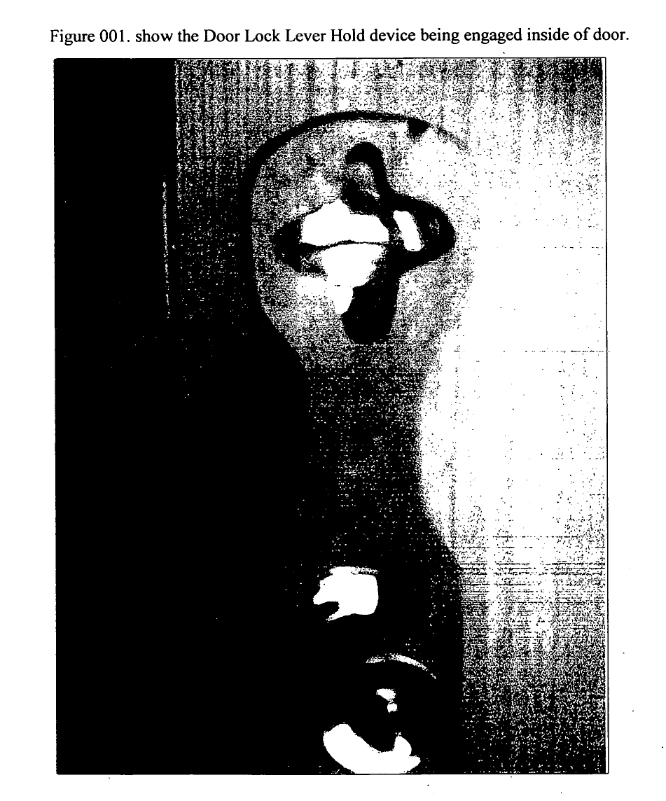

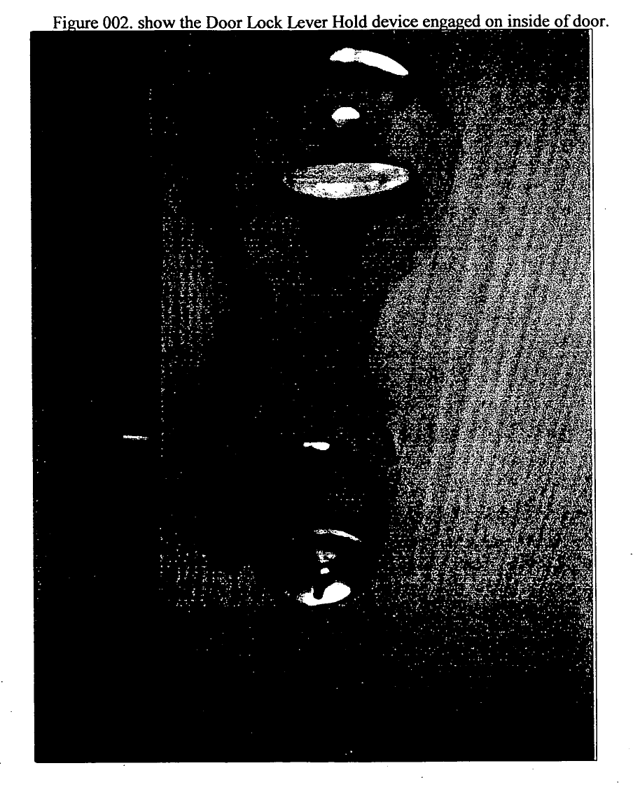

### BACKGROUND OF THE INVENTION

My invention is in the field of door locks for home entrance doors. Some entrance doors locks even though set at the locked position maybe opened by sliding a business card or a thin object between the door lock and the door's adjoining door lock cylinder mount to disengage it's inter-locking cylinder form it's mount. The dead bolt lock system is designed to prevent the use of a business card or thin objects to disengage the door lock. However if a key is lost, missing or stolen to the dead bolt lock my invention will prevent the turning of lever knob on the inside side of the home entrance door when the lever knob is of a horizontal or vertical shape and size match has been selected.

My invention dose not require any construction alterations be made to the door or the door structure when the proper size Door lock lever hold device is selected for use.

### BRIEF SUMMARY OF INVENTION

My Invention can be used when there is a need to hold the lever knob for the dead bolt lock system in a preset horizontal or vertical locked or unlocked position and will prevent the use of a key to open the lock from the outside side of the home entrance door until the device is removed from the inside side of the door. The advantage is that no entrance can be made through that entrance door until the person on the inside allow them to enter. This is helpful if a key to that dead bolt lock is lost, missing or stolen or if an account of who passes through that door would like to be known by the person or persons inside of the door.

### DETAILED DESCRIPTION OF THE INVENTION

Located at the top of the Door Lock Lever Hold device is a intersecting horizontal and vertical opening for the lever knob of the dead bolt lock that controls the locking and unlocking function for the home entrance door on the inside side of the door. Located at he back or rear of the opening are remaining sections that will anchor behind the lever knob and rest on the lever knob's axle to interlock. The sections are located at he top of the rear opening extending down-ward about 2 millimeters and are about 1 to 2 millimeters thick depending on the space between the lever knob and the door. The total depth of the opening is about ⅝″, which is the equal to the thickness of the device at the top.

The length of my invention is determined by the distance form the lever knob of the dead bolt lock on the inside side of the entrance dodo to the door knob, my device is generally about 8½″ in length. The lower section of my invention has two shafts of equal length for extending downward behind the door knob and rest on the door knob's axle to interlock as the top section is also interlocking with it's horizontal or vertical set position.

My invention is made from a wood material, a hard material such as wood, plastic or metal which is not soluble with liquids should be used to construct my invention. I have constructed templates for routing wood materials to produce my invention.

1. When the proper size Door lock lever hold device is select and engaged or used it will slide on the door lock's inside knob that rotates to lock and unlock the deadbolt locking system by interlocking with it's rectangular shape lever knob that will hold or prevent the turning or rotating of the door's deadbolt locking system from the outer side of the door with a key or other objects if using the lock's key function.

2. The Door lock lever hold device require no construction alteration made to the door or structure such as screws when the proper corresponding size device that mechanics will interlock with the deadbolt lock's lever knob which function is to turn or rotate to engage or disengage the door's deadbolt locking system.

3. The Door lock lever hold device will not slip off under normal conditions because of the section of the device that slides down and behind the deadbolt lock system lever knob and door knob from the inside.
